(19) United States
(12) Patent Application Publication
(10) Pub. No.: US 2026/0001176 A1
(43) Pub. Date: Jan. 1, 2026

(54) APPARATUS FOR PARTS SUPPLY AND LUBRICANT APPLICATION USING ROBOT

(71) Applicant: BRILS Co., Ltd., Incheon (KR)

(72) Inventor: Jin JEON, Incheon (KR)

(21) Appl. No.: 18/945,276

(22) Filed: Nov. 12, 2024

(30) Foreign Application Priority Data
Jun. 28, 2024 (KR) 10-2024-0085508

(51) Int. Cl. B23P 15/10

(52) U.S. Cl. CPC B23P 15/10

(57) ABSTRACT

The present disclosure proposes an apparatus for parts supply and lubricant application using a robot, which may automate a process for applying a lubricant to a piston to promote a piston movement of a damper and mounting an O-ring on the piston. The apparatus for parts supply and lubricant application using a robot may include a piston supply unit that supplies at least one piston, a lubricant application unit that applies the lubricant to the at least one piston supplied from the piston supply unit, an O-ring supply unit that supplies an O-ring to be mounted on the at least one piston to which the lubricant is applied by the lubricant application unit, and a first robot that transfers the at least one piston supplied by the piston supply unit to the lubricant application unit, and mounts the O-ring supplied from the O-ring supply unit on the at least one piston to which the lubricant is applied by the lubricant application unit.

### CROSS REFERENCE TO RELATED APPLICATION

This application claims priority from Republic of Korea Patent Application No. 10-2024-0085508, filed on June 28, which is hereby incorporated by reference in its entirety.

### BACKGROUND

### Field

The present disclosure relates to an automated system. More specifically, the present disclosure relates to an apparatus for parts supply and lubricant application using a robot, which can automate a process for applying a lubricant to a piston to facilitate a piston movement of a damper and mounting an O-ring on the piston.

### Description of Related Art

Grease is a substance defined as a semi-solid or solid lubricant made by mixing a thickener with a lubricating oil. This grease may include base oil, the thickener, and additives. The grease can fulfill a lubricating role in various machines by maintaining a semi-solid state when the machines are in a stationary state and maintaining a liquid state when the machines are in an operating state.

Meanwhile, a damper refers to a device that provides resistance to motion and consumes kinetic energy. This damper may be classified into an air damper using pneumatics, an oil damper using hydraulics, or the like. In general, the damper may include a cylinder having a hollow interior, a piston that reciprocates while maintaining a sealed state by using an O-ring inside the cylinder, and an endcap that couples the cylinder and the piston.

In a process for assembling the damper, a process for applying the grease to the piston is essentially required. In the related art, this grease application process is manually performed by workers. Consequently, there is a problem in that which a probability of defects is high and a loss of manpower is huge.
(Patent Document 1) Korean Patent No. 10-2571733, ‘Air Suspension Disassembly and Assembly Apparatus’ (Published on Sep. 19, 2023) is an example in the related art.

### SUMMARY

An object of the present disclosure is to provide an apparatus for parts supply and lubricant application using a robot, which can automate a process for applying a lubricant to a piston to facilitate a piston movement of a damper and mounting an O-ring on the piston.

Technical aspects of the present disclosure are not limited to the above-described technical aspects, and other technical aspects not described herein will be clearly understood by those skilled in the art from the description below.

In order to achieve the technical aspects, the present disclosure proposes an apparatus for parts supply and lubricant application using a robot, which may automate a process for applying a lubricant to a piston to promote a piston movement of a damper and mounting an O-ring on the piston. The apparatus for parts supply and lubricant application using a robot includes a piston supply unit that supplies at least one piston, a lubricant application unit that applies a lubricant to the at least one piston supplied from the piston supply unit, an O-ring supply unit that supplies an O-ring to be mounted on the at least one piston to which the lubricant is applied by the lubricant application unit, and a first robot that transfers the at least one piston supplied by the piston supply unit to the lubricant application unit, and mounts the O-ring supplied from the O-ring supply unit on the at least one piston to which lubricant is applied by the lubricant application unit.

Specifically, the piston supply unit may include a piston hopper unit that stores a plurality of pistons, a piston bowl feeder unit that receives supply of at least one piston from the piston hopper unit, a piston linear feeder unit that aligns and supplies the at least one piston supplied from the piston bowl feeder unit, and a piston mounting unit on which the at least one piston aligned by and supplied from the piston linear feeder unit is mounted.

The lubricant application unit may include a piston holder unit on which the at least one piston transferred from the first robot is mounted so that end portion of the at least one piston is exposed, and an application unit that applies the lubricant along ae circumference of the end portion of the at least one piston mounted on the piston holder unit.

the piston holder unit may rotate the at least one piston mounted according to an operation of the application unit so that the lubricant is applied along the circumference of the end portion of the at least one piston by the application unit.

The piston holder unit may include a holder on which the at least one piston is mounted, a pinion gear fixed and coupled to the holder to rotate the holder, and a rack gear that rotates the pinion gear.

The O-ring supply unit may include an O-ring hopper unit that stores a plurality of O-rings, an O-ring bowl feeder unit that receives supply of at least one O-ring from the O-ring hopper unit, an O-ring linear feeder unit that aligns and supplies the at least one O-ring supplied from the O-ring bowl feeder unit, and an O-ring placement unit on which the O-ring aligned by and supplied from the O-ring linear feeder unit is placed.

The O-ring placement unit may include an O-ring placement stand having a plurality of holes in which the O-ring supplied from the O-ring linear feeder unit is placed, and a mounting module installed in each of the plurality of holes formed in the O-ring placement stand, and expanding an inner space of the placed O-ring when the O-ring is placed in each of the plurality of holes.

The mounting module may expand the inner space of the at least one O-ring placed on the O-ring placement stand, and when the piston is inserted into the inner space of the expanded O-ring, the expansion is released to mount the at least one O-ring on the at least one piston.

The first robot may include a robot arm, and a gripping unit installed in an end portion of the robot arm, and gripping and transferring the at least one piston.

The robot arm may include a plurality of links, at least one joint that connects the plurality of links, and a gripper bracket coupled to an end portion of a terminal link in the plurality of links.

The gripping unit may include a first gripper module coupled to one side of the gripper bracket and gripping the at least one piston, and a second gripper module coupled to the other side of the gripper bracket perpendicularly to the first gripper module and gripping the at least one piston in a direction perpendicular to the at least one piston gripped by the first gripper module.

The gripping unit may be perpendicularly disposed so that the first gripper module and the second gripper module mutually form an angle of 90°.

Each of the first gripper module and the second gripper module may include a plurality of grippers that grip the at least one piston, and the plurality of grippers may be disposed apart from each other at an interval equal to an interval between the plurality of pistons mounted on the lubricant application unit.

Specific details of other embodiments are included in the detailed description and drawings.

According to embodiments of the present disclosure, a probability of defects and a loss of manpower which may occur during an assembly process may be minimized by automating a process for applying a lubricant to a piston to promote a piston movement of a damper and mounting an O-ring on the piston.

Advantageous effects of the present disclosure are not limited to advantageous effects described above, and other advantageous effects not described herein will be clearly understood by those skilled in the art to which the present disclosure belongs from the description of the appended claims.

### BRIEF DESCRIPTION OF THE DRAWING

FIG. 1 is a perspective view showing a damper assembly automation system according to one embodiment of the present disclosure.

FIG. 2 is a top view showing the damper assembly automation system according to one embodiment of the present disclosure.

FIG. 3 is a perspective view showing a piston supply unit according to one embodiment of the present disclosure.

FIG. 4 is a perspective view showing an O-ring supply unit and a lubricant application unit according to one embodiment of the present disclosure.

FIG. 5 is a perspective view showing the lubricant application unit and an O-ring placement unit according to one embodiment of the present disclosure.

FIG. 6 is a rear perspective view showing the lubricant application unit and the O-ring placement unit according to one embodiment of the present disclosure.

FIG. 7 is a perspective view showing a configuration of an endcap supply unit according to one embodiment of the present disclosure.

FIG. 8 is a perspective view showing a configuration of a body supply unit according to one embodiment of the present disclosure.

FIG. 9 is a perspective view showing a configuration of a press-fitting unit according to one embodiment of the present disclosure.

FIG. 10 is a rear perspective view showing a configuration of the press-fitting unit according to one embodiment of the present disclosure.

FIG. 11 is a perspective view showing an assembly inspection and classification device according to one embodiment of the present disclosure.

FIG. 12 is a rear perspective view showing the assembly inspection and classification device according to one embodiment of the present disclosure.

FIG. 13 is a side view showing a first robot according to one embodiment of the present disclosure.

FIG. 14 is a perspective view showing a configuration of a gripping unit according to one embodiment of the present disclosure.

FIG. 15 is a flowchart for describing a damper assembly automation method according to one embodiment of the present disclosure.

### DETAILED DESCRIPTION

It should be noted that the technical terms used in this specification are used only to describe specific embodiments, and are not intended to limit the present disclosure. In addition, the technical terms used in this specification should be construed as having a meaning generally understood by those having ordinary skill in the art to which the present disclosure belongs, unless specifically defined otherwise herein, and should not be construed in an overly comprehensive or overly narrow sense. In addition, when the technical term used in this specification is an incorrect technical term that does not accurately express the idea of the present disclosure, it should be understood that the incorrect technical term is replaced with a technical term that can be correctly understood by those skilled in the art. In addition, general terms used in the present disclosure should be construed as defined in the dictionary or according to the context, and should not be construed in an overly narrow sense.

In addition, the singular expression used in this specification includes a plurality of expressions unless the context clearly indicates otherwise. In the present application, the terms “configured to include” or “having” should not be construed as necessarily including all of various components or various steps described in the specification, and should be construed as not including some of the components or some of the steps, or as including additional components or steps.

In addition, terms including ordinal numbers such as first, second, or the like used in this specification may be used to describe various components, but the components should not be limited by the terms. The terms are used only to distinguish one component from another component. For example, without exceeding the scope of the rights of the present disclosure, a first component may be referred to as a second component, and similarly, the second component may also be referred to as the first component.

When it is described that a component is “connected” or “linked” to another component, a component may be directly connected or linked to another component, but other components may exist therebetween. On the other hand, when it is described that a component is “directly connected” or “directly linked” to another component, it should be understood that other components do not exist therebetween.

Hereinafter, preferred embodiments according to the present disclosure will be described in detail with reference to the accompanying drawings. Regardless of the drawing numbers, the same reference numbers will be assigned to identical or similar components, and repeated description thereof will be omitted. In addition, when it is determined that specific description of the related publicly known technology in the present disclosure may obscure the concept of the present disclosure, detailed description thereof will be omitted. In addition, it should be noted that the accompanying drawings are only intended to facilitate understanding of the idea of the present disclosure, and should not be construed as limiting the idea of the present disclosure by the accompanying drawings. The idea of the present disclosure should be construed to extend to all modifications, equivalents, or substitutes in addition to the accompanying drawings.

Meanwhile, a damper assembly process includes a process for applying a lubricant to a piston, mounting an O-ring on the piston to which the lubricant is applied, and mounting an endcap and a cylinder on the piston on which the O-ring is mounted. In addition, the assembled damper necessarily requires a process for inspecting whether an intended damping force is generated.

In the related art, assembly and inspection processes of the dampers are manually performed by workers. Consequently, during an assembly process, there is a problem in that a probability of defects is high and a loss of manpower is huge.

In order to overcome these limitations, the present disclosure proposes various means for automating the assembly process of the damper.

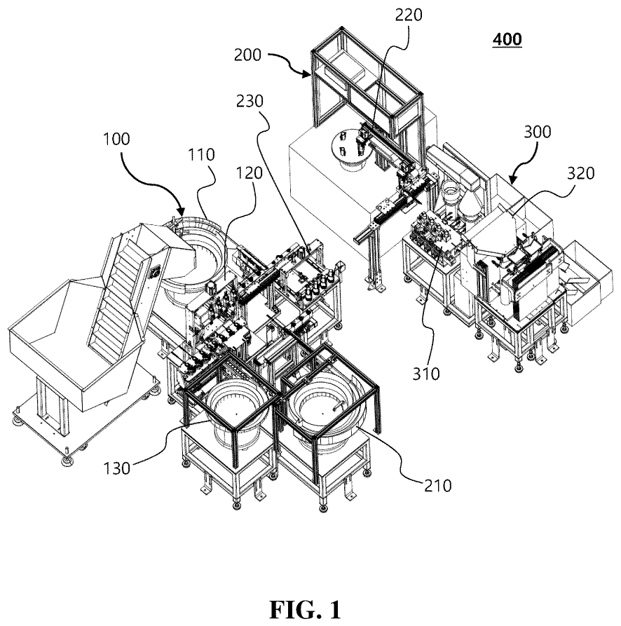

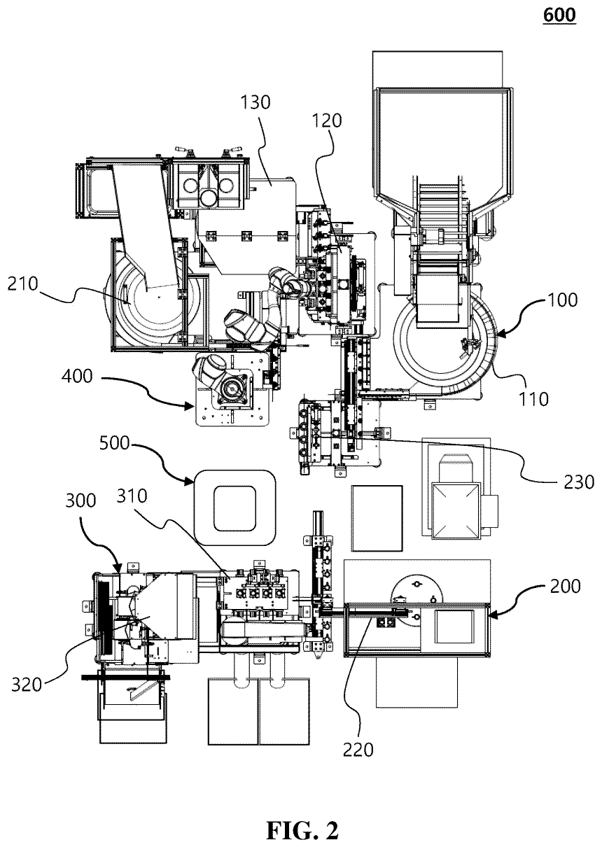

FIG. 1 is a perspective view showing a damper assembly automation system according to one embodiment of the present disclosure, and FIG. 2 is a top view showing the damper assembly automation system according to one embodiment of the present disclosure.

Referring to FIGS. 1 and 2, a damper assembly automation system (600) according to one embodiment of the present disclosure may include a lubricant application device (100), a damper assembly automation device (200), an assembly inspection and classification device (300), a first robot (400), and a second robot (500).

Meanwhile, the damper assembly automation system (600) according to one embodiment of the present disclosure may adopt various types of dampers such as an oil damper and an air damper. The following description is based on a damper including a piston, an O-ring, an endcap, and a body.

With regard to each component, the lubricant application device (100) may automate a process for applying the lubricant to the piston to promote a piston movement of the damper and mounting the O-ring on the piston.

Specifically, the lubricant application device (100) may include a piston supply unit (110) that supplies at least one piston, a lubricant application unit (120) that applies the lubricant to the at least one piston supplied from the piston supply unit (110), an O-ring supply unit (130) that supplies an O-ring to be mounted on the at least one piston to which the lubricant is applied by the lubricant application unit (120), and the first robot (400) that transfers the at least one piston supplied by the piston supply unit (110) to the lubricant application unit (120) and that mounts the O-ring supplied from the O-ring supply unit (130) on the at least one piston to which the lubricant is applied by the lubricant application unit (120).

Meanwhile, a specific configuration of the lubricant application device (100) will be described later with reference to the drawings.

According to the following configuration, the damper assembly automation device (200) may automate an assembly process for a piston, an endcap, and a body on which the O-ring forming the damper is mounted.

Specifically, the damper assembly automation device (200) may include an endcap supply unit (210) that supplies at least one endcap to be assembled to the piston, a body supply unit (220) that supplies at least one body to be assembled to the endcap, a press-fitting unit (230) that press-fits and assembles the body when the at least one piston assembled with the endcap is seated and the body is coupled to the at least one piston assembled with the seated endcap, the first robot (400) that assembles the piston to the at least one endcap supplied from the endcap supply unit (210) and transfers the at least one piston assembled with the endcap to the press-fitting unit (230), and a second robot (500) that transfers and assembles the at least one body supplied from the body supply unit (220) to the press-fitting unit.

Meanwhile, a specific configuration of the damper assembly automation device (200) will be described later with reference to the drawings.

According to the following configuration, the assembly inspection and classification device (300) may automate a process for inspecting an assembled damper.

Specifically, the assembly inspection and classification device (300) may include an inspection unit (310) that inspects at least one assembled damper, a discharge unit (320) that discharges the inspected damper from the inspection unit (310), and the second robot (500) that classifies the at least one damper according to an inspection result of the inspection unit (310) and discharges the inspected damper through the discharge unit (320).

Meanwhile, a specific configuration of the assembly inspection and classification device (300) will be described later with reference to the drawings.

Hereinafter, a configuration of the piston supply unit (110) according to one embodiment of the present disclosure will be described in detail.

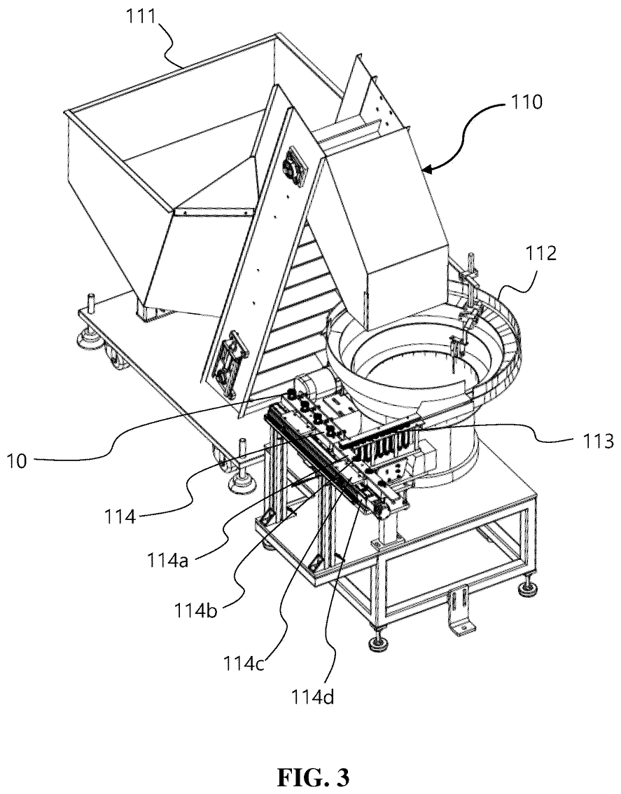

FIG. 3 is a perspective view showing the piston supply unit according to one embodiment of the present disclosure.

Referring to FIG. 3, the piston supply unit (110) according to one embodiment of the present disclosure may include a piston hopper unit (111), a piston bowl feeder unit (112), a piston linear feeder unit (113), and a piston placement unit (114).

With regard to each configuration, the piston hopper unit (111) may store a plurality of pistons (10). Specifically, the piston hopper unit (111) may internally have a space for storing the plurality of pistons (10). When the piston bowl feeder unit (112) is short of the piston (10), the piston (10) may be automatically supplied to the piston bowl feeder unit (112).

Next, the piston bowl feeder unit (112) may receive supply of at least one piston (10) from the piston hopper unit (111), and may deliver the supplied at least one piston (10) to the piston linear feeder unit (113). Specifically, the piston bowl feeder unit (112) may be formed in a bowl shape to form a space for storing the piston (10), may align the stored piston (10) in a constant posture by using vibration, and may deliver the piston (10) to the piston linear feeder unit (113).

According to the following configuration, the piston linear feeder unit (113) may align at least one piston (10) supplied from the piston bowl feeder unit (112), and may deliver at least one piston (10) to the piston placement unit (114). Specifically, the piston linear feeder unit (113) may horizontally align the pistons (10) supplied from the piston bowl feeder unit (112), and may individually supply the pistons (10) to the piston placement unit (114).

According to the following configuration, the piston placement unit (114) may place at least one piston (10) individually supplied and aligned from the piston linear feeder unit (113). Specifically, the piston placement unit (114) may include a piston placement stand (114a) having a plurality of holes (114b) on which the piston (10) supplied from the piston linear feeder unit (113) is mounted, a piston placement stand moving unit (114c) that horizontally moves the piston placement stand (114a) by an interval between the plurality of holes (114b) when the piston (10) is mounted on one of the plurality of holes (114b), and a piston placement stand guide bar (114d) that guides the horizontal movement of the piston placement stand moving unit (114c). Here, the plurality of holes (114b) may be formed apart by a preset interval. In addition, each of the plurality of holes (114b) may have a space through which the piston (10) may pass on a side surface in a direction of the piston linear feeder unit (113). Accordingly, the piston (10) supplied from the piston linear feeder unit (113) may be mounted after being introduced through the space.

Hereinafter, configurations of the lubricant application unit (120) and the O-ring supply unit (130) according to one embodiment of the present disclosure will be described in detail.

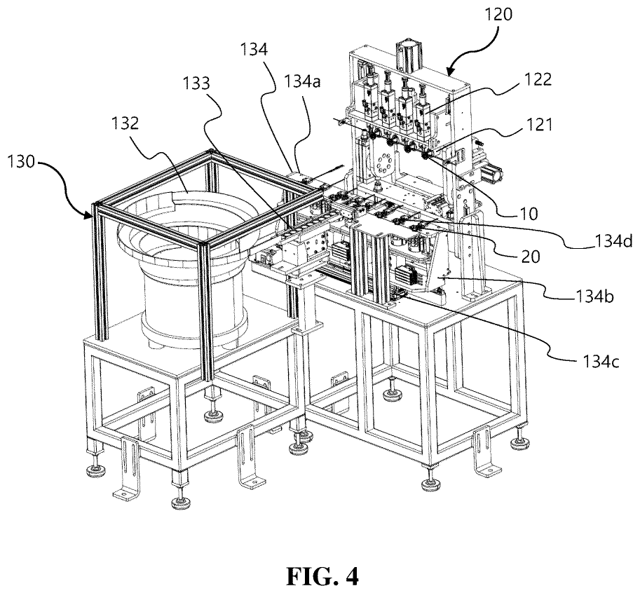

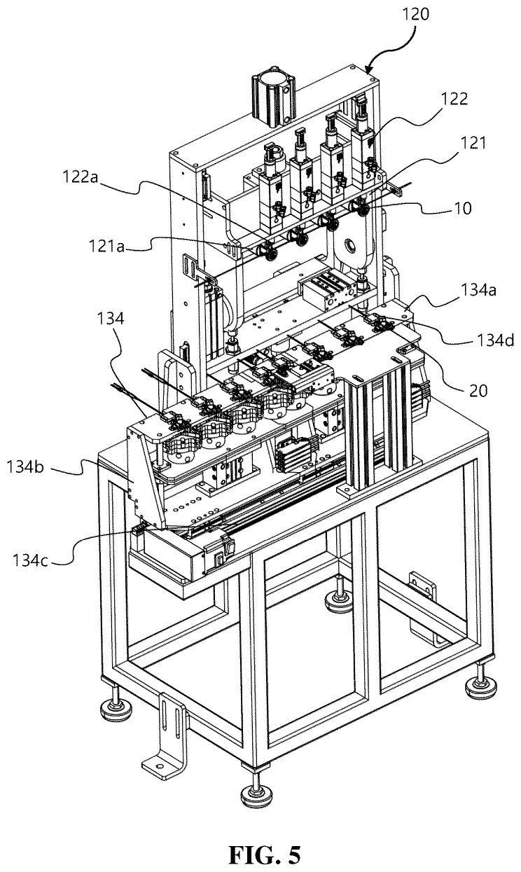

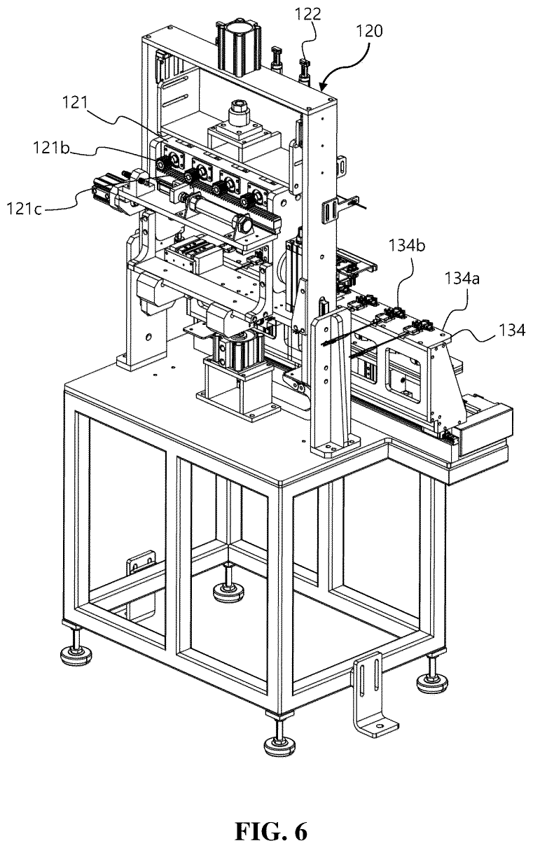

FIG. 4 is a perspective view showing the O-ring supply unit and the lubricant application unit according to one embodiment of the present disclosure, FIG. 5 is a perspective view showing the lubricant application unit and the O-ring placement unit according to one embodiment of the present disclosure, and FIG. 6 is a rear perspective view showing the lubricant application unit and the O-ring placement unit according to one embodiment of the present disclosure.

Referring to FIGS. 4 to 6, the lubricant application unit (120) according to one embodiment of the present disclosure may include a piston holder unit (121) and an application unit (122).

With regard to each configuration, the piston holder unit (121) may be mounted so that an end portion of the at least one piston (10) transferred from the first robot (400) is exposed in a direction horizontal to the ground. Specifically, the piston holder unit (121) may rotate the mounted at least one piston (10) according to an operation of the application unit (122), and the application unit (122) may apply the lubricant along a circumference of the end portion of the at least one piston (10).

For this purpose, the piston holder unit (121) may include a holder (121a) on which the at least one piston is mounted, a pinion gear (121b) fixed and coupled to the holder (121a) to rotate the holder (121a), and a rack gear (121c) that rotates the pinion gear (121b). That is, when the at least one piston (10) is mounted on the holder (121a), the piston holder unit (121) may rotate the piston (10) by horizontally moving the rack gear (121c) in a preset direction and rotating a plurality of the pinion gears (121b) connected to the holder (121a) interlocked with the rack gear (121c). In this case, a rotation speed of the piston (10) may be set depending on the amount of the lubricant applied from the application unit (122).

According to the following configuration, the application unit (122) may apply the lubricant along the circumference of the end portion of the at least one piston mounted on the piston holder unit (121). Specifically, the application unit (122) may include a nozzle (122a) that applies the lubricant while being located in each upper portion of the at least one piston (10) mounted on the piston holder unit (121). When the at least one piston (10) mounted on the piston holder unit (121) rotates, the lubricant may be applied along the circumference of the end portion of the piston (10).

The lubricant may be viscous semi-solid grease. For example, the lubricant may adopt various types of grease such as calcium soap grease, sodium soap grease, aluminum soap grease, lithium soap grease, mixed soap grease, non-soap grease, and complex grease.

In addition, the O-ring supply unit (130) according to one embodiment of the present disclosure may include an O-ring hopper unit (131), an O-ring bowl feeder unit (132), an O-ring linear feeder unit (133), and an O-ring placement unit (134).

With regard to each configuration, the O-ring hopper unit (131) may store a plurality of O-rings (20). Specifically, the O-ring hopper unit (131) may internally have a space for storing the plurality of O-rings (20). When the O-ring bowl feeder unit (132) is short of the O-ring (20), the O-ring (20) may be automatically supplied to the O-ring bowl feeder unit (132).

According to the following configuration, the O-ring bowl feeder unit (132) may receive supply of at least one O-ring (20) from the O-ring hopper unit (131), and may deliver the supplied at least one O-ring (20) to the O-ring linear feeder unit (133). Specifically, the O-ring bowl feeder unit (132) may be formed in a bowl shape to form a space for storing the O-ring (20), may align the stored O-ring (20) in a constant posture by using vibration, and may deliver the O-ring (20) to the O-ring linear feeder unit (133).

According to the following configuration, the O-ring linear feeder unit (133) may align the at least one O-ring (20) supplied from the O-ring bowl feeder unit (132), and may deliver the at least one O-ring (20) to the O-ring placement unit (134). Specifically, the O-ring linear feeder unit (133) may horizontally align the O-rings (20) supplied from the O-ring bowl feeder unit (132), and may individually supply the O-rings (20) to the O-ring placement unit (134).

According to the following configuration, the O-ring placement unit (134) may include an O-ring placement stand (134a), an O-ring placement stand moving unit (134b), an O-ring placement stand guide bar (134c), and a mounting module (134b).

The O-ring placement stand (134a) may place the at least one O-ring (20) aligned and individually supplied from the O-ring linear feeder unit (133). Specifically, the O-ring placement stand (134a) may have a plurality of holes on which the O-ring (20) supplied from the O-ring linear feeder unit (133) is mounted.

The O-ring placement stand moving unit (134b) may horizontally move the O-ring placement stand (134a) by an interval between the plurality of holes when the O-ring (20) is mounted on one of the plurality of holes. The O-ring placement stand guide bar (134c) may guide the horizontal movement of the O-ring placement stand moving unit (134b).

The mounting module (134b) may be installed inside each of the plurality of holes of a placement stand (134a), may expand the inner space of the at least one O-ring (20) mounted on the placement stand (134a). When the piston (10) is inserted into the inner space of the expanded O-ring, the expansion of the O-ring (20) may be released to mount the O-ring (20) on the piston (10).

Hereinafter, a configuration of the endcap supply unit (210) according to one embodiment of the present disclosure will be described in detail.

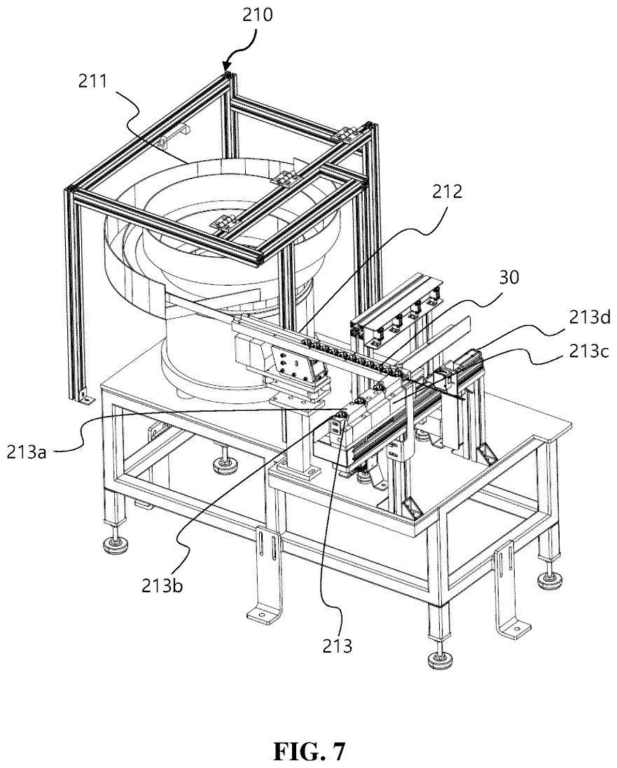

FIG. 7 is a perspective view showing the configuration of the endcap supply unit according to one embodiment of the present disclosure.

Referring to FIG. 7, the endcap supply unit (210) according to one embodiment of the present disclosure may include an endcap bowl feeder unit (211), an endcap linear feeder unit (212), and an endcap placement unit (213).

With regard to each configuration, the endcap bowl feeder unit (211) may supply at least one endcap (30). Specifically, the endcap bowl feeder unit (211) may be formed in a bowl shape to form a space for storing the endcap (30), and the stored endcap (30) may be aligned in a constant posture by using vibration, and may be delivered to the endcap linear feeder unit (212).

According to the following configuration, the endcap linear feeder unit (212) may align at least one endcap (30) supplied from the endcap bowl feeder unit (211), and may deliver the at least one endcap (30) to the endcap placement unit (213). Specifically, the endcap linear feeder unit (212) may horizontally align the endcaps (30) supplied from the endcap bowl feeder unit (211), and may individually supply the endcaps (30) to the endcap placement unit (313).

According to the following configuration, the endcap placement unit (213) may place at least one endcap (30) aligned and individually supplied from the endcap linear feeder unit (212). Specifically, the endcap placement unit (213) may include an endcap placement stand (213a) having a plurality of holes (213b) on which the endcap (30) supplied from the endcap linear feeder unit (212) is mounted, an endcap placement stand moving unit (213c) that horizontally moves the endcap placement stand (213a) by an interval between the plurality of holes (213b) when the endcap (30) is mounted on one of the plurality of holes (213b), and an endcap placement stand guide bar (213d) that guides the horizontal movement of the endcap placement stand moving unit (213c). Here, the plurality of holes (213b) may be formed apart by a preset interval. In addition, each of the plurality of holes (213b) may have a space through which the endcap (30) may pass on a side surface in a direction of the endcap linear feeder unit (212). Accordingly, the endcap (30) supplied from the endcap linear feeder unit (212) may be mounted after being introduced through the space.

Hereinafter, a configuration of the body supply unit (220) according to one embodiment of the present disclosure will be described in detail.

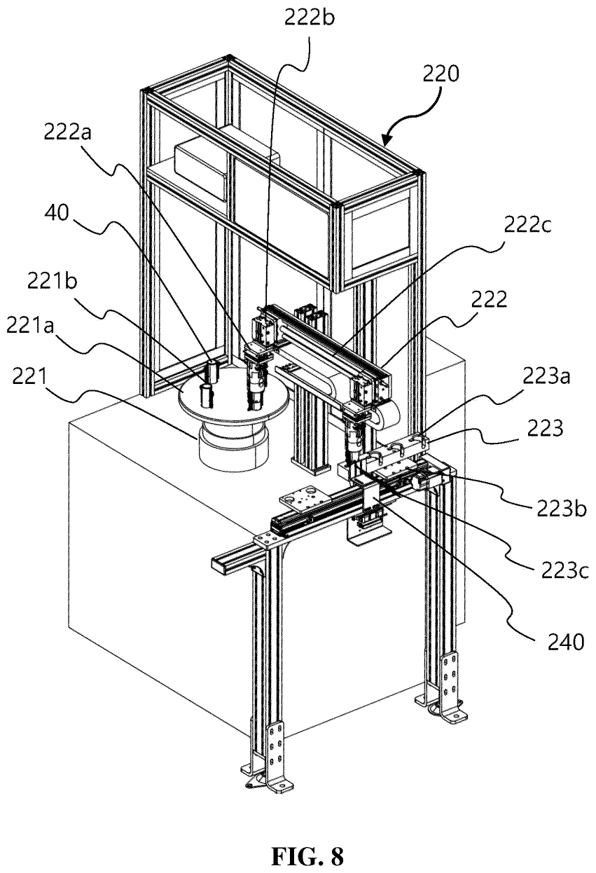

FIG. 8 is a perspective view showing the configuration of the body supply unit according to one embodiment of the present disclosure.

Referring to FIG. 8, the body supply unit (220) according to one embodiment of the present disclosure may include a body holder unit (221), a body transfer unit (222), a body placement unit (223), and a lubricant inspection unit (224).

With regard to each configuration, at least one body (40) may be mounted on the body holder unit (221). Here, the lubricant may be applied in advance to the body (40) mounted on the body holder unit (221). The body holder unit (221) may include a turntable (221a) and a body holder (221b).

The turntable (221a) may be formed in a circular table shape, and may locate the body (40) at a preset position gripped by a picker (222a) of the body transfer unit (222) by rotating the body holder (221b). The body holder (221b) may have a plurality of holes disposed at a preset interval along a circumferential direction of the turntable (221a), and at least one body (40) may be mounted on the body holder (221b).

According to the following configuration, the body transfer unit (222) may transfer at least one body (40) mounted on the body holder unit (221). Specifically, when one of the bodies (40) mounted on the body holder (221b) is located at a preset position by the turntable (221a), the body transfer unit (222) may grip the body (40) located at the preset position, or may place the body (40) on the body placement unit (223) after releasing the gripping. This body transfer unit (222) may include a picker (222a), a body transfer module (222b), and a body transfer guide bar (222c).

When one of the bodies (40) mounted on the body holder (221b) is located at the preset position by the turntable (221a), the picker (222a) may grip the body (40) located at the preset position, or may place the body (40) on the body placement unit (223) after releasing the gripping. The picker (222a) may correspond to various types of pickers capable of gripping the body (40). For example, the picker (222a) may adopt various types of grippers capable of gripping the body (40), such as a forceps gripper, a pressure-sensitive gripper, and a vacuum gripper.

When the body (40) is gripped by the picker (222a), the body transfer module (222b) may transfer the picker (222a) to the body placement unit (223). The body transfer guide bar (222c) may guide the movement of the body transfer module (222b).

According to the following configuration, the body placement unit (223) may place at least one body (40) transferred by the body transfer unit (222). The body placement unit (223) may include a body placement stand (223a), a body placement stand transfer module (223b), and a body placement stand transfer guide bar (223c).

The body placement stand (223a) may have a plurality of holes formed apart at a preset interval to place the body (40). Here, the plurality of holes may be formed in a shape corresponding to a shape of the body (40). In a state where the body (40) is placed in one of the plurality of holes by the picker (222a),) when the lubricant inspection unit (240) (to be described later) confirms whether the lubricant is normally applied, the body placement stand (223a) may be shifted by an interval between the plurality of holes by the body placement stand transfer module (223b.

The body placement stand transfer module (223b) may be fixed and coupled to the body placement stand (223a), and may transfer the body placement stand (223a). That is, in a state where the body (40) is placed in one of the plurality of holes of the body placement stand (223a) by the picker (222a), when the lubricant inspection unit (240) confirms whether the lubricant is normally applied, the body placement stand (223a) may be moved by an interval between the plurality of holes. The body placement stand transfer guide bar (223c) may guide the movement of the body placement stand transfer module (223b).

The lubricant inspection unit (224) may generate an image for the body (40) placed on the body placement unit (223), and may inspect a lubricant application state of the body (40), based on the generated image. For example, the lubricant inspection unit (224) may include a camera capable of acquiring an image by imaging the body (40) placed on the body placement unit (223). For example, the camera may include any one of a color camera, a near infrared (NIR) camera, a short wavelength infrared (SWIR) camera, and a long wavelength infrared (LWIR) camera. The lubricant inspection unit (224) may inspect at least one of whether the lubricant is applied and the lubricant application state, based on the captured image.

Hereinafter, a configuration of the press-fitting unit (230) according to one embodiment of the present disclosure will be described in detail.

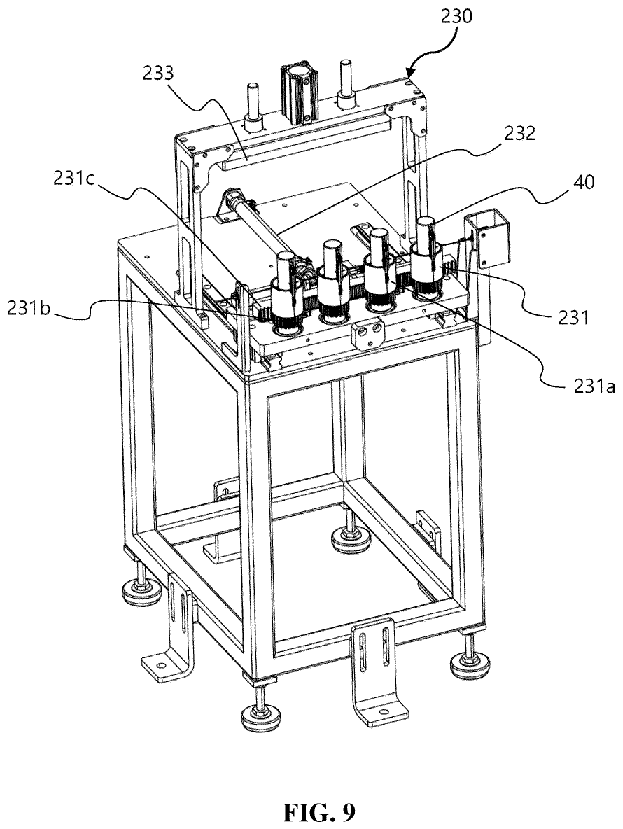

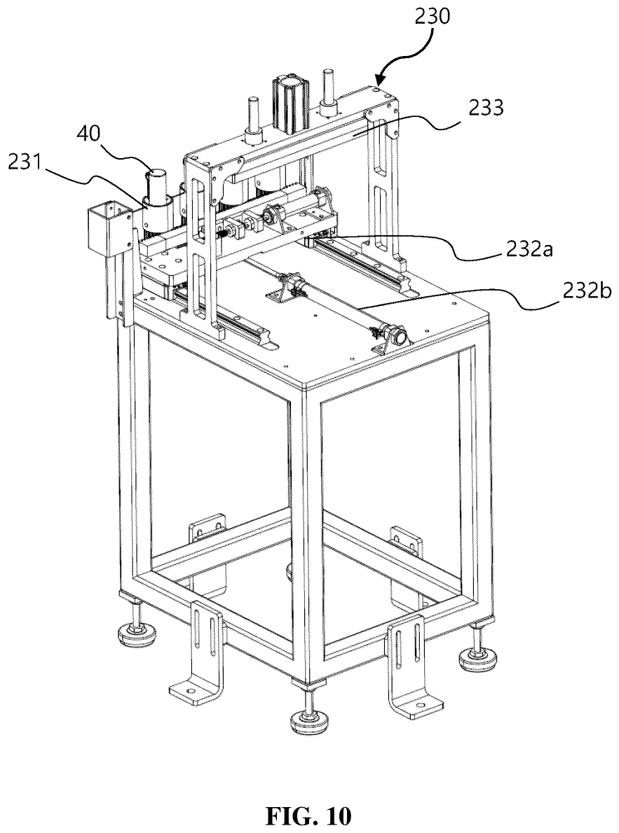

FIG. 9 is a perspective view showing the configuration of the press-fitting unit according to one embodiment of the present disclosure, and FIG. 10 is a rear perspective view showing the configuration of the press-fitting unit according to one embodiment of the present disclosure.

Referring to FIGS. 9 and 10, the press-fitting unit (230) according to one embodiment of the present disclosure may include a seating jig (231), a jig transfer module (232), and a press-fitting module (233).

With regard to each configuration, the piston (10) to which at least one endcap (30) is assembled may be seated on the seating jig (231). Here, when the body of the seating jig (231) is coupled to the piston (10) to which at least one endcap (30) is assembled, the body (40) may be rotated and fixed to the endcap (30). This seating jig (231) may include a plurality of jigs (231a), pinion gears (231b) fixed and coupled to the plurality of jigs (231a) to rotate the jigs (231a), and a rack gear (231c) that rotates the pinion gears (231b).

That is, after the piston (10) in which endcap (30) is assembled to each of the plurality of jigs (231a) by the first robot (400) is mounted, when the body (40) is mounted on the plurality of jigs (231a) on which with the piston (10) is mounted by the second robot, the seating jig (231) may horizontally move the rack gear (231c) in a preset direction, and may rotate the body (40) by rotating the plurality of pinion gears (231b) connected to the plurality of jigs (231a) interlocked with the rack gear (231c). In this case, one side of the body (40) may be hooked on and fixed to a groove formed in the jig (231a) to rotate together with the jig (231a), and the endcap (30) may be fixed separately from the jig (231a) to be coupled to the body (40) by screwing. Here, the endcap (30) and the body (40) may have a mutually corresponding female screw thread or male screw thread.

According to the following configuration, the jig transfer module (232) may transfer the seating jig (231) to a preset position when the body (40) is coupled to at least one endcap (30) seated on the seating jig (231). Specifically, the jig transfer module (232) may include a jig transfer unit (232a) and an actuator (232b).

The jig transfer unit (232a) may be fixed and coupled to the seating jig (231) in an upper portion, and when the body (40) is coupled to at least one endcap (30) seated on the seating jig (231), the seating jig (231) may be moved rearward by the actuator (232b) to be located in a lower portion of the press-fitting module (233).

One end portion of the actuator (232b) may be coupled to the jig transfer unit (232a), and when the body (40) is coupled to at least one endcap (30) seated on the seating jig (231), the jig transfer unit (232a) may be moved rearward in a direction of the press-fitting module (233). For example, the actuator (232b) may adopt various types of actuators capable of moving the seating jig (231) forward or rearward, such as a hydraulic cylinder and a pneumatic cylinder.

According to the following configuration, the press-fitting module (233) may completely assemble the body (40) to the endcap (30) by press-fitting an upper portion of the body (40) when the body (40) coupled to the endcap (30) by the jig transfer module (232) is located at a preset position. The press-fitting module (233) may adopt various types of press-fitting devices capable of press-fitting the upper portion of the body (40), such as a hydraulic press method and a pneumatic press method.

Hereinafter, a configuration of the assembly inspection and classification device (300) according to one embodiment of the present disclosure will be described in detail.

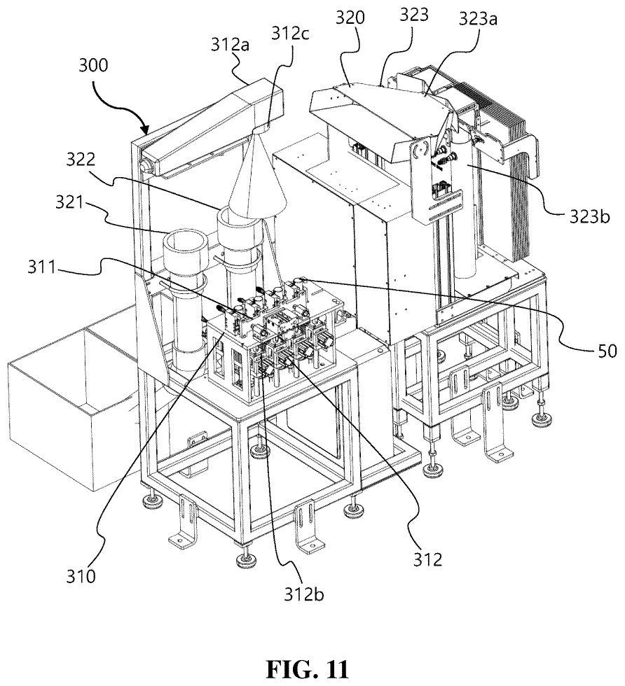

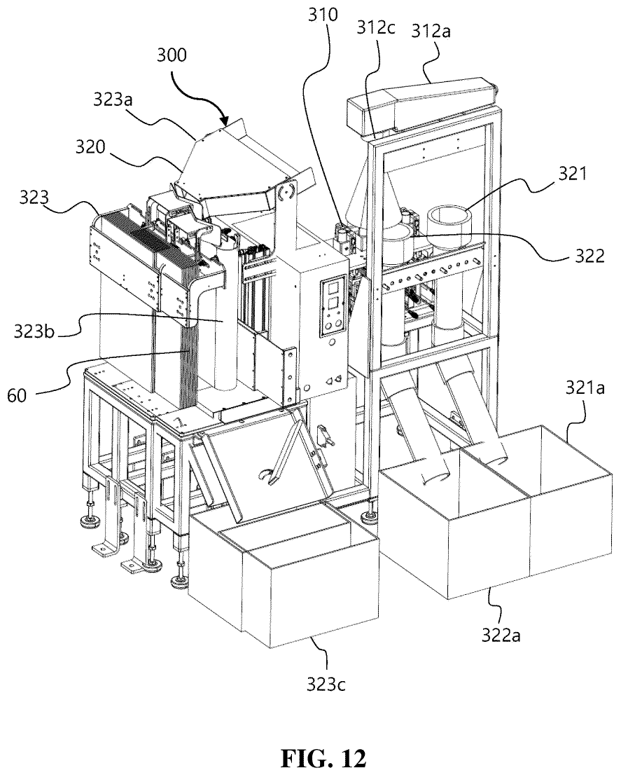

FIG. 11 is a perspective view showing the assembly inspection and classification device according to one embodiment of the present disclosure. FIG. 12 is a rear perspective view showing the assembly inspection and classification device according to one embodiment of the present disclosure.

Referring to FIGS. 11 and 12, the assembly inspection and classification device (300) according to one embodiment of the present disclosure may include the inspection unit (310) and the discharge unit (320).

With regard to each configuration, the inspection unit (310) may inspect at least one assembled damper.

Specifically, the inspection unit (310) may include a damper fixing unit (311) and an inspection unit (312).

The damper fixing unit (311) may fix at least one assembled damper (50) transferred by the second robot (500). More specifically, the damper fixing unit (311) may grip and fix the body (40) of at least one assembled damper (50).

The inspection unit (312) may inspect at least one assembled damper (50) when at least one assembled damper (50) is fixed to the damper fixing unit (311). The inspection unit (312) may include a vision inspection module (312a), a damping inspection module (312b), and a marking module (312c).

The vision inspection module (312a) may generate an image for at least one assembled damper (50) fixed to the damper fixing unit (311), and may inspect a state of at least one assembled damper (50), based on the generated image. For example, the vision inspection module (312a) may inspect a color of the damper, or whether the damper has external damage. For example, the vision inspection module (312a) may include a camera capable of capturing an image by imaging at least one assembled damper (50) placed on the damper fixing unit (311). For example, the camera may include any one of a color camera, a near infrared (NIR) camera, a short wavelength infrared (SWIR) camera, and a long wavelength infrared (LWIR) camera.

The damping inspection module (312b) may inspect a damping force of at least one assembled damper (50) fixed to the damper fixing unit (311). For this purpose, the damping inspection module (312b) may insert a piston pin into a hole formed in the piston (10) exposed downward of the damper fixing unit (311), and may apply a preset pressure in a direction of gravity by fixing a weight to the inserted piston pin. In this case, the damping inspection module (312b) may fix the weight to the piston pin to age the piston a preset number of times, may release the fixed weight, may measure a free fall time of the piston, and may inspect at least one assembled damper, based on the measured free fall time.

The marking module (312c) may mark identification information corresponding to a qualified product on the damper determined as the qualified product by the vision inspection module (312a) and the damping inspection module (312b). For example, the marking module (312c) may engrave a preset phrase for identifying the damper as the satisfactory product by irradiating the body of the damper with the laser. For example, the marking module (312c) may engrave a model name, a product number, or the like of the damper.

According to the following configuration, the discharge unit (320) may discharge the inspected damper (50) from the inspection unit (310). The discharge unit (320) may include a vision defect discharge unit (321), a damping defect discharge unit (322), and a qualified product discharge unit (333). In this way, the discharge unit (320) may simplify a separate sorting process by segmenting, classifying, and discharging types of defects in the damper.

The vision defect discharge unit (321) may discharge the damper determined as defective by the vision inspection module (312a). Specifically, when the damper determined as defective by the vision inspection module (312a) is loaded by the second robot (500), the vision defect discharge unit (321) may discharge the loaded damper to a vision defect damper case (321a).

The damping defect discharge unit (322) may discharge the damper determined as defective by the damping inspection module (312b). Specifically, when the damper determined as defective by the damping inspection module (312b) is loaded by the second robot (500), the damping defect discharge unit (322) may discharge the loaded damper to a damping defect damper case (322a).

The qualified product discharge unit (223) may discharge the damper determined as the qualified product by the vision inspection module (312a) and the damping inspection module (312b). The qualified product discharge unit (223) may include a loading module (223a) and a packaging module (223b). The damper determined as the qualified product may be loaded into the input module (223a) by the second robot (500). The packaging module (223b) may package the damper loaded from the loading module (223a). Here, the packaging module (223b) may supply a packaging material (60) for packaging the damper determined as the qualified product loaded from the input module (223a). When a preset number of the dampers are loaded into the packaging material (60), the packaging material (60) may be sealed and discharged to a qualified product damper case (323c). In this case, the packaging module (223b) may estimate the number of the dampers loaded into the packaging material (60), based on a weight of the dampers loaded into the packaging material (60).

Hereinafter, a configuration of the first robot according to one embodiment of the present disclosure will be described in detail.

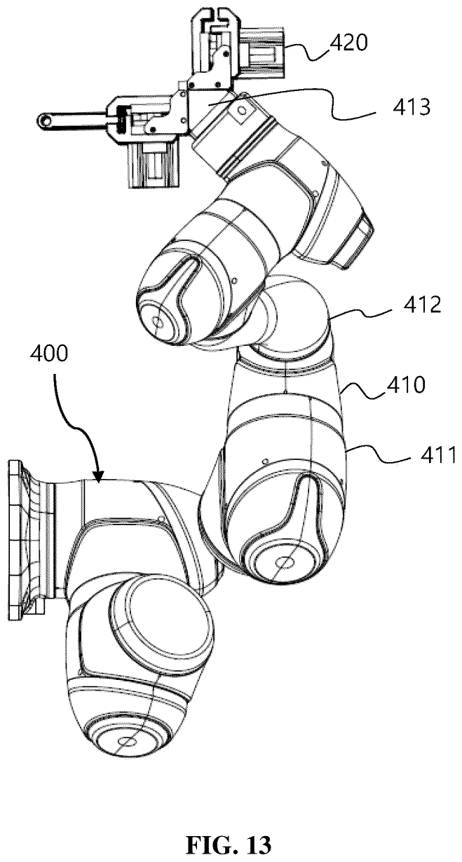

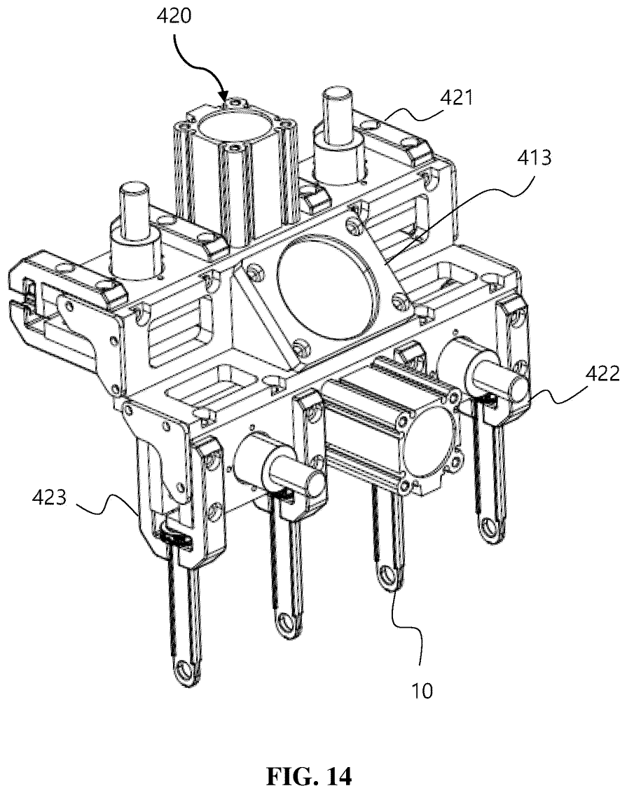

FIG. 13 is a side view showing the first robot according to one embodiment of the present disclosure, and FIG. 14 is a perspective view showing a configuration of the gripping unit according to one embodiment of the present disclosure.

Meanwhile, the first robot (400) has substantially the same structure as the second robot (500). Therefore, the first robot (400) will be mainly described below.

Referring to FIGS. 13 and 14, the first robot (400) may include a robot arm (410) and a gripping unit (420).

The robot arm (410) may include a plurality of links (411), at least one joint (412) connecting the plurality of links (411), and a gripper bracket (413) coupled to an end portion of a terminal link in the plurality of links (411).

The gripping unit (420) may include a first gripper module (421) coupled to one side of the gripper bracket (413) and gripping at least one piston (10), and a second gripper module (422) coupled to the other side of the gripper bracket (413) perpendicularly to the first gripper module (421) and gripping at least one piston (10) in a direction perpendicular to at least one piston (10) gripped by the first gripper module (421).

Here, the first gripper module (421) and the second gripper module (422) may be disposed to mutually form an angle of 90°. Through this configuration, the first robot (400) may shorten a process time by minimizing a movement range in a fixing process for applying the lubricant and a process for mounting the O-ring.

Here, each of the first gripper module (421) and the second gripper module (422) may include a preset number of a plurality of grippers (423). Here, the plurality of grippers (423) may be disposed apart at an equal interval equal to an interval between the plurality of pistons (10) mounted on the lubricant application unit (220). More specifically, the plurality of grippers (423) may be disposed at an interval equal to an interval between the plurality of holders (121a) of the lubricant application unit (122), an interval between the plurality of holes formed in the O-ring placement stand (134a), and an interval between the plurality of jigs (231a).

The first robot (400) may transfer at least one piston (10) supplied by the piston supply unit (110) to the lubricant application unit (120), and may mount the O-ring (20) supplied from the O-ring supply unit (130) on at least one piston (10) to which the lubricant is applied by the lubricant application unit (120).

In addition, the first robot (400) may assemble the piston (10) to at least one endcap (30) supplied from the endcap supply unit (210), and may transfer at least one piston (10) to which the endcap (30) is assembled to the press-fitting unit (230).

The second robot (500) may transfer at least one body (40) supplied from the body supply unit (220) to the press-fitting unit (230), and may assemble the body (40) to the piston (10) to which the endcap (30) is assembled.

In addition, the second robot (500) may classify at least one damper, based on an inspection result of the inspection unit (310), and may discharge the damper through the discharge unit (320).

Hereinafter, a damper assembly automation method according to one embodiment of the present disclosure will be described.

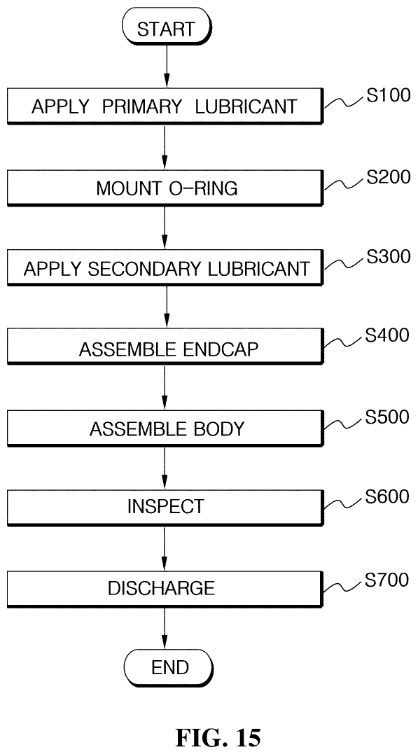

FIG. 15 is a flowchart for describing the damper assembly automation method according to one embodiment of the present disclosure.

Referring to FIG. 15, in Step S100, the damper assembly automation system may transfer at least one piston supplied by the piston supply unit to the lubricant application unit through the first robot. The damper assembly automation system may apply a primary lubricant to the piston through the lubricant application unit.

Next, in Step S200, the damper assembly automation system may use the first robot to grip the piston to which the primary lubricant application is completely applied, and may insert the piston into the inner space of the O-ring placed on the O-ring placement unit. When the piston is completely inserted, the damper assembly automation system may release the expansion of the O-ring through the mounting module of the O-ring placement unit so that the O-ring is mounted on the piston.

Next, in Step S300, the damper assembly automation system may transfer the piston on which the O-ring is mounted again to the lubricant application unit through the first robot. The damper assembly automation system may apply a secondary lubricant to the piston on which the O-ring is mounted through the lubricant application unit.

Next, in Step S400, the damper assembly automation system may transfer the piston on which the O-ring to which the lubricant is completely applied is mounted to the endcap placed on the endcap placement unit through the first robot, and thereafter, may assemble the piston on which the O-ring to which the lubricant is completely applied is mounted to the placed endcap.

Next, in Step S500, the damper assembly automation system may seat the piston to which the endcap is completely assembled on the seating jig through the first robot. When the piston to which the endcap is completely assembled is seated on the seating jig, the damper assembly automation system may primarily assemble the body supplied from the body supply unit through the second robot to the endcap seated on the seating jig.

The damper assembly automation system may transfer the seating jig to the press-fitting unit, and may press-fit the upper portion of the assembled body through the press-fitting unit to secondarily assemble the body to the endcap.

Next, in Step S600, the damper assembly automation system may transfer the assembled damper seated on the seating jig to the inspection unit through the second robot. Thereafter, the damper assembly automation system may inspect whether the assembled damper is defective through the inspection unit.

In Step S700, the damper assembly automation system may classify the defective product or the qualified product through the second robot, and may discharge the classified product through the discharge unit.

As described above, although the present specification and drawings have disclosed preferred embodiments of the present disclosure, it will be apparent to those skilled in the art that other modifications based on the technical idea of the present disclosure may be implemented in addition to the embodiments disclosed herein. In addition, although specific terms have been used in the present specification and drawings, the specific terms have been used only in a general sense to easily describe the technical contents of the present disclosure and to facilitate understanding of the invention, and are not intended to limit the scope of the present disclosure. Accordingly, the detailed description should not be construed as restrictive in all aspects, and should be considered as illustrative. The scope of the present disclosure should be selected by a reasonable interpretation of the appended claims, and all changes within the equivalent scope of the present disclosure are included in the scope of the present disclosure.

### REFERENCE SIGNS LIST

100: Lubricant application device
110: Piston supply unit
120: Lubricant application unit
130: O-ring supply unit
200: Damper assembly automation device
210: Endcap supply unit
220: Body supply unit
230: Press-fitting unit
300: Assembly inspection and classification device
310: Inspection unit
320: Discharge unit
400: First robot
500: Second robot
600: Damper assembly automation system

1. An apparatus for parts supply and lubricant application using a robot, comprising:
a piston supply unit that supplies at least one piston;
lubricant application unit that applies a lubricant to the at least one piston supplied from the piston supply unit;
an O-ring supply unit that supplies an O-ring to be mounted on the at least one piston to which the lubricant is applied by the lubricant application unit; and
a first robot that transfers the at least one piston supplied by the piston supply unit to the lubricant application unit, and mounts the O-ring supplied from the O-ring supply unit on the at least one piston to which lubricant is applied by the lubricant application unit.

2. The apparatus for parts supply and lubricant application using a robot of claim 1, wherein the piston supply unit includes a piston hopper unit that stores a plurality of pistons, a piston bowl feeder unit that receives supply of at least one piston from the piston hopper unit, a piston linear feeder unit that aligns and supplies the at least one piston supplied from the piston bowl feeder unit, and a piston mounting unit on which the at least one piston aligned by and supplied from the piston linear feeder unit is mounted.

3. The apparatus for parts supply and lubricant application using a robot of claim 1, wherein the lubricant application unit includes a piston holder unit on which the at least one piston transferred from the first robot is mounted so that end portion of the at least one piston is exposed, and an application unit that applies the lubricant along ae circumference of the end portion of the at least one piston mounted on the piston holder unit.

4. The apparatus for parts supply and lubricant application using a robot of claim 3, wherein the piston holder unit rotates the at least one piston mounted according to an operation of the application unit so that the lubricant is applied along the circumference of the end portion of the at least one piston by the application unit.

5. The apparatus for parts supply and lubricant application using a robot of claim 4, wherein the piston holder unit includes a holder on which the at least one piston is mounted, a pinion gear fixed and coupled to the holder to rotate the holder, and a rack gear that rotates the pinion gear.

6. The apparatus for parts supply and lubricant application using a robot of claim 1, wherein the O-ring supply unit includes an O-ring hopper unit that stores a plurality of O-rings, an O-ring bowl feeder unit that receives supply of at least one O-ring from the O-ring hopper unit, an O-ring linear feeder unit that aligns and supplies the at least one O-ring supplied from the O-ring bowl feeder unit, and an O-ring placement unit on which the O-ring aligned by and supplied from the O-ring linear feeder unit is placed.

7. The apparatus for parts supply and lubricant application using a robot of claim 6, wherein the O-ring placement unit includes an O-ring placement stand having a plurality of holes in which the O-ring supplied from the O-ring linear feeder unit is placed, and a mounting module installed in each of the plurality of holes formed in the O-ring placement stand, and expanding an inner space of the placed O-ring when the O-ring is placed in each of the plurality of holes.

8. The apparatus for parts supply and lubricant application using a robot of claim 1, wherein the first robot includes a robot arm, and a gripping unit installed in an end portion of the robot arm, and gripping and transferring the at least one piston.

9. The apparatus for parts supply and lubricant application using a robot of claim 8, wherein the robot arm includes a plurality of links, at least one joint that connects the plurality of links, and a gripper bracket coupled to an end portion of a terminal link in the plurality of links.

10. The apparatus for parts supply and lubricant application using a robot of claim 9, wherein the gripping unit includes a first gripper module coupled to one side of the gripper bracket and gripping the at least one piston, and a second gripper module coupled to the other side of the gripper bracket perpendicularly to the first gripper module and gripping the at least one piston in a direction perpendicular to the at least one piston gripped by the first gripper module.
